(19) United States
(12) Patent Application Publication
(10) Pub. No.: US 2017/0308911 A1
(43) Pub. Date: Oct. 26, 2017

(54) SHOPPING CART TRACKING SYSTEM AND METHOD FOR ANALYZING SHOPPING BEHAVIORS

(71) Applicants: Candice Barham, Aliso Viejo, CA (US); Corinne Barham, Encinitas, CA (US)

(72) Inventors: Candice Barham, Aliso Viejo, CA (US); Corinne Barham, Encinitas, CA (US)

(21) Appl. No.: 15/135,349

(22) Filed: Apr. 21, 2016

(51) Int. Cl. G06Q 30/02; H04W 4/02

(52) U.S. Cl. CPC G06Q 30/0201; H04W 4/02

(57) ABSTRACT

System and method for monitoring a shopping cart location is disclosed. The system and method tracks the location of the shopping cart within a store to identify a shopping behavior of a customer. A RF tag is integrated with the shopping cart and communicates with a reference point to identify the location of the shopping cart in real time. In addition to the location, the system identifies time, duration, and trail of the shopping cart during a shopping activity. The system and method to analyze the acquired data to improve an overall shopping experience of the customer is further disclosed.

### BACKGROUND

### Field of the Invention

The subject matter described herein relates generally to real-time locating system. More specifically, the present disclosure is related to locating a shopping cart within a store and analyzing a shopping behavior of a shopper based on a pattern identified by tracking the movement of a shopping cart. In addition, the present disclosure provides a shopping cart that is suitable for moving in a confined space.

### Description of Related Art

Traditional shopping carts impose several issues and problems. Traditional shopping carts are typically built to provide a large receptacle to retain as many merchandises as possible. They are too bulky for large retail locations, such as a shopping mall, that have escalators and stairs.

In order to analyze the customer's need and to improve the shopping experience, it is necessary to analyze a pattern of the shoppers in a store. Reducing a foot traffic or placing the merchandise in an optimized fashion can not only increase sales, but also can prevent the loss of shoppers' visits due to fatigue and unpleasant shopping experience. Macro and micro identification of the shoppers' foot traffic and traffic patterns can help determine an optimized placement of merchandise and control traffic of the shoppers. Among other benefits, the present disclosure may help manage the customer traffic better and manage the control of the shopping experience.

Therefore, what is needed is a shopping cart that provides more freedom of movement within a crowded and narrow space. There also is a need to provide a system and method that tracks movement of a shopper to analyze the shopper's behavior and purchase pattern. Such a system and method can improve the shopping experience, in turn increase the traffic and the revenue for a store.

### SUMMARY

The subject matter of this application may involve, in some cases, interrelated products, alternative solutions to a particular problem, and/or a plurality of different uses of a single system or article.

In one aspect, a system for monitoring a shopping cart location is provided. The system may comprise one or more shopping carts, each of which equipped with an RF module. The system may further comprise one or more reference points in communication with the RF module. The one or more reference points may be positioned to provide a communication network between the RF module and the one or more reference points throughout a store area. One or more processors may be in communication with the one or more reference points and a storage unit, the storage unit stores data received from the one or more reference points. The system may identify a location in relation to time, a duration of use, and a trail, of the one or more shopping carts within the store area. The one or more processors may determine a shopping behavior based on the identified information.

In another aspect, a method for monitoring the location of one or more shopping carts is provided. Each of the one or more shopping carts are equipped with an RF module. The method may be operated by one or more processors, where the one or more processors is in communication with a storage unit. The method may begin with defining a communication network between the RF module and one or more reference points within a store area, by arranging the one or more reference points throughout the store area. Further, the one or more processor may identify a location of the one or more shopping carts in relation to time within the store area, where the location is identified based on data received from the one or more reference points. The one or more processors may be in communication with the one or more reference points and the storage unit storing data received from the one or more reference points. The method may continue with identifying a duration of the one or more shopping carts being used by a user and a trail of the one or more shopping carts while in use in relation to time. Finally, the one or more processors may determine a shopping behavior based on a behavior data. The behavior data may comprise the identified, location, duration, and trail of the one or more shopping carts.

### BRIEF DESCRIPTION OF THE DRAWINGS

FIG. 1 provides an exemplary embodiment of the shopping cart.

FIG. 2 provides an exemplary embodiment of the system for monitoring the shopping cart location.

FIG. 3 provides an exemplary embodiment of the reference points placements in multiple aisles.

FIG. 4 provides an exemplary embodiment of the reference point placements in multiple stores.

FIG. 5 provides a flowchart describing an exemplary method for determining a shopping behavior.

FIG. 6 provides a flowchart describing an exemplary method for determining the purchase pattern.

FIG. 7 provides a flowchart describing an exemplary method for recommending item placement.

FIG. 8 provides a flowchart describing an exemplary method for correlating user profile with the behavior data.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components, and materials have not been described in detail as not to unnecessarily lengthen the present disclosure.

It should be understood that if an element or part is referred herein as being “on”, “against”, “in communication with”, “connected to”, “attached to”, or “coupled to” another element or part, then it can be directly on, against, in communication with, connected, attached or coupled to the other element or part, or intervening elements or parts may be present. When used, the term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Various operations may be described as multiple discrete operations in turn, in a manner that may be helpful in understanding embodiments; however, the order of description should not be construed to imply that these operations are order dependent.

Spatially relative terms, such as “under” “beneath”, “below”, “lower”, “above”, “upper”, “proximal”, “distal”, and the like, may be used herein for ease of description and/or illustration to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable. Such descriptions are merely used to facilitate the discussion and are not intended to restrict the application of disclosed embodiments.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Generally, the present invention concerns a system for monitoring a location of a shopping cart. The present invention provides a system and a method for tracking the location and/or the movement of the shopping cart being used by a user. Further, the present invention concerns a system and a method for analyzing a shopper's shopping behavior and purchase pattern based on the monitoring of the shopping cart.

The system for monitoring a location of a shopping cart may comprise one or more computers, one or more processors, or computerized elements, in communication with one another via a network, working together to carry out the different functions of the system provided herein. The invention contemplated herein may further comprise a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system may comprise a computerized user interface provided in one or more computing devices, such as a user device, in networked communication with each other. The computer or computers of the computerized user interface contemplated herein may comprise a memory (a storage unit), processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

Database and data contemplated herein may be in the format including, but are not limiting to, XML, JSON, CSV, binary, over any connection type: serial, Ethernet, wireless, etc. over any protocol: UDP, TCP, and the like.

Computer or computing device contemplated herein may include, but are not limited to, virtual systems, Cloud/remote systems, desktop computers, laptop computers, tablet computers, handheld computers, smartphones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, PTP over IP networks (PTP/IP), and Transmission Control Protocol over IP (TCP/IP).

Specifically, Radio Frequency (RF) communication contemplated herein may include, for example, a short range communication format of magnetic induction, 9 kHz, <125 kHz, 125 kHz RFID, 13.56 MHz, 433 MHz, 433 MHz RFID, and 900 MHz RFID; a medium range communication format, such as Zigbee, Bluetooth, Bluetooth low energy (BLE), WiFi, Low-power WiFi, Ultrasound and Infrared communication formats; or any other RF network types. Person having ordinary skill in the art would comprehend the variety of communication formats applicable to the present invention.

An apparatus for retaining and carrying one or more items is provided. The apparatus, also referred to as a shopping cart, is designed to be operated within a confined space, such as an elevator or on an escalator. In light of the current state of the pertinent art, there has been a long-felt need for such shopping cart.

The shopping cart may comprise a base, a pole, and an RF module. The base may comprise a plurality of wheels that enable movement of the shopping cart. The base may be sized to fit on a confined space, such as inside an elevator and an escalator step.

In one embodiment, the base may form a plurality of legs radially extending away from the base, where each of the plurality of the legs are connected to one or more wheels contacting a surface. In some embodiments, the wheels may be in the form of casters.

In another embodiment, a pole may be formed vertically by the base in an upright orientation. The pole may provide a body to detachably retain one or more shopping bags. In some embodiments, multiple fasteners, such as hooks, carabiners, and the like, may be positioned along the pole. The multiple fasteners may provide a mechanism to releasably retain the one or more shopping bags. In some embodiments, the pole may be extendable and/or retractable, for example a telescopic pole.

In yet another embodiment, the shopping cart may comprise a receptacle, such as a basket, to retain the items/merchandise.

The RF module may be operatively connected to the shopping cart. The RF module may be applied in various RF communication formats. The RF module may be a tag that transmits signals to a reference point which detects the signal originated from the RF module/tag.

In one embodiment, the shopping cart may be equipped with a RF module. The RF module may be in communication with the reference point, in turn the reference point may be in communication with a central computing unit that collects data and signal generated from/to the reference point and/or the RF module. A real-time locating system may be employed. Generally, the real-time locating system enables identifying and tracking a location of the shopping cart based on the communication among the RF module, the reference point, and the central computing unit. The reference point receives wireless signal, in various RF communication format, from the RF module to determine its location.

The RF module may be attached to the shopping cart. In some embodiments, the RF module may be integrated with the body of the shopping cart.

In another embodiment, the RF module may be a transmitter, a receiver, and/or a transceiver. The communication channel between the RF module and the reference point may be two-way.

In yet another embodiment, the shopping cart may be in communication with one or more processors to process the data received by and transmitted from the reference point and/or the RF module. The method and process of utilizing the data, such as the location data of the shopping cart, are illustrated below.

In a further embodiment, the RF module may be coupled to a battery unit to power the RF module. The battery unit may be rechargeable.

A system for monitoring a shopping cart location is provided. The system may comprise a plurality of the shopping carts, one or more of the reference points, and the central computing unit. The central computing unit may run on a local server, a remoter server, or within a various types of network described above. The reference points may receive a signal from the RF module coupled to each of the plurality of shopping carts. In turn, the reference points may be in communication with the central computing unit. The central computing unit may comprise one or more processors, a storage unit (database), a computerized user interface, and any combination thereof.

In one embodiment, the reference points may be positioned throughout a store area to provide a communication network/coverage among the components of the present system. The reference points may be distributed within the store defining the covered store area. The communication between the reference points and the RF module may enable identification of the RF module's location.

In another embodiment, one or more reference points may be positioned at each aisles of the store area. The store may comprise multiple aisles, such as a grocery store, for example. The reference point positioned at the aisle may identify when the shopping cart enters and exits the aisle, by communicating with the RF module of the shopping cart. The reference point positioned at the aisle also may identify how long the shopping cart stays in a certain aisle. The reference points may also enable tracking a trail or a path of the movement of the shopping cart within a certain aisle, in/out of the aisle, and similarly throughout the covered store area.

In yet another embodiment, similar to the reference point application to the aisles, one or more reference points may be positioned at each stores. The store area may contain multiple stores, such as a shopping mall, for example. The reference point positioned at each stores may identify when the shopping cart enters and exits the store, by communicating with the RF module of the shopping cart. The reference point positioned at the store also may identify how long the shopping cart stays in a certain store. The reference points may also enable tracking a trail or a path of the movement of the shopping cart within a certain store, in/out of the store, and similarly throughout the covered store area.

Information related to the aisles and the stores discussed above may be stored in the storage unit. The types of merchandise or items being sold at the aisles/stores may be categorized for further analysis.

The reference points positioned at the aisles or the stores may be a proximity sensor type that detects the shopping cart passing by the proximity sensor.

In a further embodiment, each shopping carts may be linked to a unique identification detectable by the reference point, in order to distinguish the plurality of shopping carts. The identification may be in various data format. Each RF modules of the plurality of shopping carts may be tagged with such identification.

In a further embodiment, the store area may contain multiple floor levels. The present system may identify which of the multiple floor levels the shopping cart may be located. A floor reference point may be positioned at each of the multiple floor levels communicating with the RF module. Once the shopping cart enters a certain floor level and the floor reference point identifies the RF module entering the certain floor level, a store area or a store map matching that floor level may be loaded. In some embodiments, the floor reference point may be a proximity type sensor. A multiple floor reference points may be positioned at each of the entrances/exits of the floor level to detect the presence of the shopping cart.

Types of the merchandise being sold at each of the multiple floor levels may be tagged and stored at the storage unit. The types of merchandise or items being sold at each of the multiple floor levels may be categorized for further analysis. For example, a shopping mall contains multiple floor levels categorized into cosmetics, jewelry, clothing, kitchenware, toys, and the like.

In a further embodiment, the store area may include a checkout terminal. One or more reference points may be positioned at the checkout terminal to identify the shopping cart at the checkout terminal. A reference point may be specifically designated to a checkout terminal, referred to as a checkout terminal reference point. The checkout terminal reference point may be positioned at the checkout terminal to detect when the shopping cart enters/exits the checkout terminal. In some embodiments, the checkout terminal reference point may be a proximity sensor type.

In a further embodiment, the shopping cart may be equipped with a sensor that identifies an item being placed at the shopping cart for purchase. Once the user picks an item to store in the shopping cart, the sensor may detect that an item has been placed. In some embodiments, the sensor may identify the item itself and/or its type. For example, the sensor may be an optical scanner, such as a barcode reader, that reads a machine-readable representation of data such as, a barcode, a QR code, and the like.

In yet another embodiment, the system for monitoring a shopping cart location may comprise a user device. The user device may be a personalized computing device such as a cell phone. A computerized user interface may be provided by the user device. The user device may receive user profile about the user using the shopping cart. The user profile may include, but not limited to, age, occupation, gender, income level, and the like. Such user profile information may be correlated with the shopping cart location information described above to identify a shopping behavior.

The central computing unit of the present system may use the components of the system to apply the method and process hereafter described.

A method for monitoring a shopping cart location is provided. The method may begin with setting up the communication coverage of the store area.

In one embodiment, the communication coverage may be defined by positioning the one or more reference points. The one or more reference points may be strategically placed in order to provide a maximum coverage within the store area. In some embodiments, specific locations of the store area and/or specific location of interest may be covered by the one or more reference points. Examples of the specific locations and location of interest may include, an entrance, an exit, a checkout terminal, an aisle, a section, a floor level, a store, and the like.

In another embodiment, the communication coverage may exclude certain locations within the store area, when such locations have limited access to the users.

Once the one or more reference points are distributed within the store area to define the communication coverage, the RF module of the shopping cart may be identified by the one or more reference points as it moves within the covered store area. In turn, the central computing unit may identify the location of the shopping cart within the store area.

In one embodiment, the location of the shopping cart may be tracked in relation to time. The location of the shopping cart may be identified with a time stamp at that location. The time may include hours, minutes, seconds, days, years, months, and the like. The identified location of the shopping cart may be logged at the storage unit for further analysis. In some embodiments, the location of the shopping cart and its time may be identified at the specific location. For example, the central computing unit may identify an initial time of entrance to an aisle (a location), an exit time out of the aisle, thus a duration of visit to the aisle. The one or more reference points, the floor reference point, and the checkout terminal reference point may be utilized for tracking the shopping cart visiting the specific location and any other locations within the store area.

In another embodiment, the central computing unit may identify a duration of the shopping cart at a location within the store area. The duration may be determined based on the lapsed time of the shopping cart at a certain location or within its vicinity.

In yet another embodiment, the central computing unit may identify a trail or a path of the shopping cart's movement while the shopping cart is in use by the user. The trail may provide time, location, and a duration of the shopping cart in use. For example, the trail may include a first location the shopping cart was positioned, a first duration at a certain specific location, a second location once the shopping cart moves, a second duration at a certain specific location, and so on.

The time, location, duration, and trail of the shopping cart collected by the central computing unit may be referred to as a behavior data. The behavior data may be further analyzed to identify a shopping behavior or a pattern of the shopping cart, hence a behavior of the user at the store area. The behavior data may be analyzed to identify certain correlations, causal relations, and tendency among the collected behavior data.

The item being picked up by the user to the shopping cart may be identified by the sensor equipped by the shopping cart. The type of the item may be identified. Similarly, the type of the item may be identified by the optical scanner. In some embodiments, the shopping cart may be equipped with a sensor that detects an item being retained by the shopping cart.

In one embodiment, a plurality of items at the store area may be categorized into types. The type may be categorized based on various criteria, such as fashion, grocery, sports, and the like. The storage unit may contain an item-to-type list preconfigured at the storage unit.

In another embodiment, a plurality of items at the store area may be categorized into types based on the location where the item is picked up. The specific locations and/or the location of interest may be linked to items being carried within the specific locations and/or the location of interest. In an exemplary embodiment, the sensor may detect that an item is picked up. The location of the shopping cart may be identified to determine the type of the picked up item based on the types of items linked at that location. The links between the items and the locations may be preconfigured at the storage unit.

The behavior data may further comprise the item type or its identification for further analysis of the shopping behavior. A purchase pattern may be determined by the central computing unit based on the behavior data. In one embodiment, the purchase pattern of the type of items may be identified with regards to time, duration, and trail. While the user picks up multiple items, the central computing unit may identify when the first item was placed at the shopping cart (time) and how long it took to place the first item (duration). The second item's pick up time and duration-to-pick-up can also be identified in a similar fashion. As such, the purchase pattern may include the trail of the user picking up the multiple items, for example from the first item to the second item. The determined purchase pattern can be utilized to study the behavior of the shoppers. For example, based on the purchase pattern, the multiple items can be placed within the store area strategically to improve the shopping experience. For example, the first item and the second item may be often bought by multiple users over time during a single visit to the store. Thus, the purchase pattern may suggest that the first item and the second item may be placed closed to one another.

In some embodiments, the checkout terminal reference point may be utilized as an exit point. The behavior data may include the time the shopping cart passed through the checkout terminal reference point to determine the duration of the entire shopping experience at the store area. The beginning of the shopping experience may be determined by either identifying the initial activation of the shopping cart or the time the shopping cart is registered by the reference point at an entrance to the store area. In some embodiments, the checkout terminal reference point may be utilized to measure the duration it takes to transact the items at the checkout terminal. In a further embodiment, the checkout terminal reference point may be utilized to prevent loss at the store by identifying any shopping carts that does pass through the checkout terminal.

Further analysis of the behavior data may suggest various shopping behaviors of the user. Different applications of the behavior data analysis may result in an identification of various shopping behaviors. The behavior data, the shopping behavior, and its applications may be provided by the central computing unit in a report. The report may be provided to a store admin or personnel.

In one embodiment, the shopping behavior may determine a traffic amount at a location within the store area. The central computing unit may determine how crowded it gets at a certain location at a certain time. Tracking the locations of multiple shopping carts at a certain location may provide a number of shopping carts at that location at a given time. The central computing unit may rank the locations within the store area based on the traffic amount to identify a pattern. For example, during a Christmas season, stores that carry Christmas ornaments may have a larger traffic in comparison to during the summer. Similarly, other patterns/shopping behaviors may be identified by determining the traffic amount.

In another embodiment, the shopping behavior may determine a frequency of visit to a location within the store area. The central computing unit may observe and identify the number of visits during a certain duration to determine how often the users visit a certain location. Based on the identified frequency of visit, the stores and/or the aisles may be placed within the store area strategically to improve the shopping experience. For example, the most frequently visited stores may be placed near the entrance of the store area in order to prevent the store from being overcrowded.

In yet another embodiment, the shopping behavior determined based on the behavior data and the purchase pattern may suggest a strategic item placement within the store area. The central computing unit may identify the purchase pattern of a multiple items. For example, the purchase pattern may include the trail of the user picking up the multiple items. Based on the trail of the purchase pattern involving a certain types of items, the central computing unit may recommend item placements. For example, if many users tend to frequently purchase the first item and the second item consecutively, the central computing unit may recommend to place the first item and the second item close to one another.

The central computing unit may utilize the user profile to determine the shopping behavior. In some embodiments, the central computing unit may receive user profile about the user using the shopping cart. The user profile may include, but not limited to, age, occupation, gender, income level, and the like. Such user profile information may be correlated with the behavior data to determine a shopping behavior commonly shared by the users having a common user profile. In an exemplary embodiment, users, in an age group between 15 to 25 and gender as male, may have a tendency/pattern to shop most frequently at a location such as sports, gaming, or electronics. Based on such identified shopping behavior in relation to a user profile, items, stores, and/or aisles may be paired.

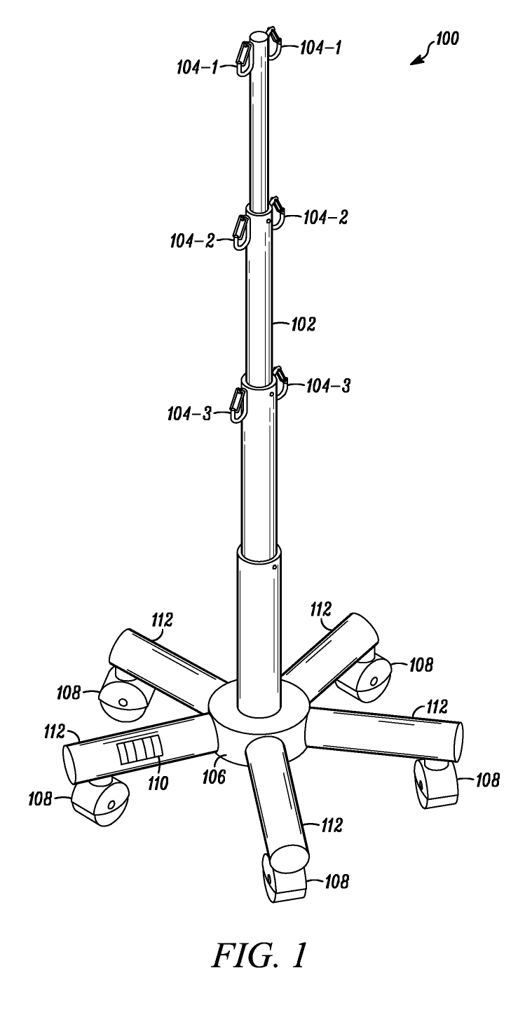

Turning now to FIG. 1, FIG. 1 illustrates an exemplary embodiment of the shopping cart 100. The shopping cart 100 comprises a pole 102 and a base 106. A plurality of legs 112 may be formed by the base 106, radially extending away from the base 106. Each of the multiple caster wheels 108 are attached to the end of each of the plurality of legs 112. At the pole 102, multiple carabiners (104-1, 104-2, and 104-3) are placed to retain shopping bags or items picked up by the user operating the shopping cart 100. The pole 102 may be extendable, for example a telescopic extension mechanism as shown in FIG. 1. The RF module 110 is placed at one of the plurality of legs 112.

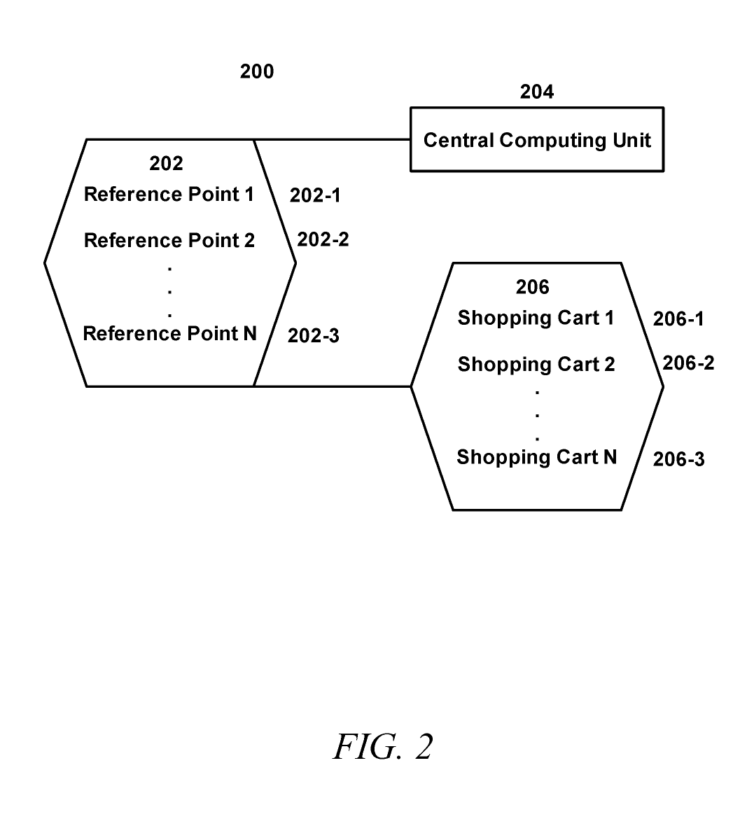

FIG. 2 shows an exemplary embodiment of the system for monitoring the shopping cart location. The system 200 comprises a plurality of reference points 202-1 202-2 202-3 (collectively referred to as 202). The plurality of reference points 202 are in communication with the central computing unit 204. The central computing unit 204 receives data/signal from the plurality of reference points 202 over a network. The central computing unit 204 may comprise one or more processors and may be in communication with the storage unit. The system 200 further comprises a plurality of shopping carts 206-1 206-2 206-3 (collectively referred to as 206). Each of the plurality of shopping carts 206 are equipped with the RF module. Thus, each of the plurality of shopping carts 206 are in communication with the plurality of reference points 202. The location of the RF module is identified by the central computing unit 204 via the communication network shown in the system 200. In turn, locations of the plurality of shopping carts 206 are identifiable via the RF module.

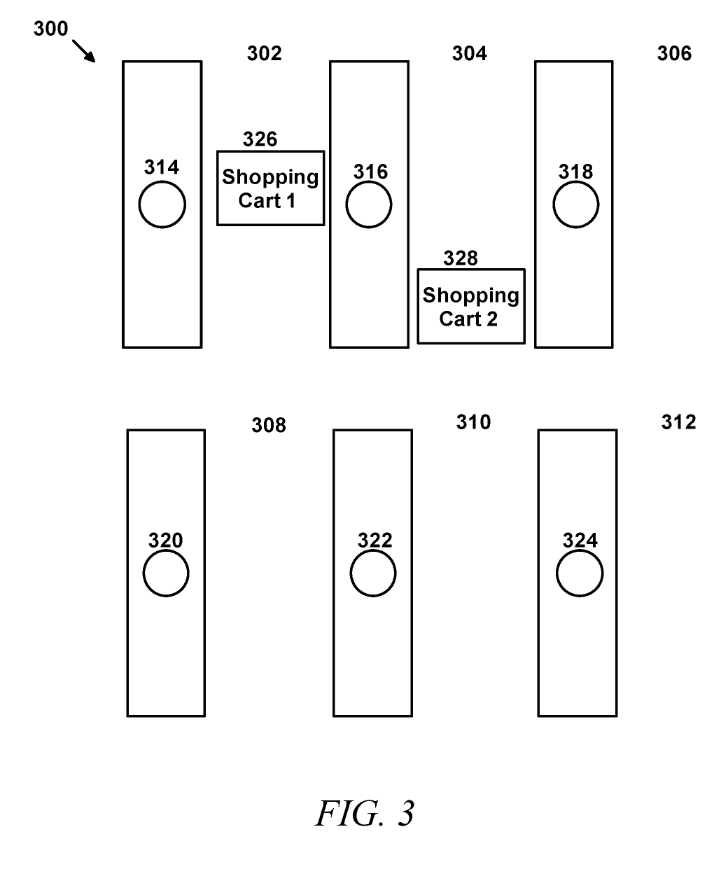

FIG. 3 illustrates an exemplary embodiment of the reference point placements in multiple aisles. The store area 300 comprises the multiple aisles, aisle 1 302, aisle 2 304, aisle 3 306, aisle 4 308, aisle 5 310, and aisle 6 312. The reference point is placed at each of the multiple aisles to identify locations of the shopping carts, for example cart 1 326 and cart 2 328, within the multiple aisles. In this exemplary embodiment, the reference point is assigned to each of the multiple aisles, namely the reference point 1 314, the reference point 2 316, the reference point 3 318, the reference point 4 320, the reference point 5 322, and the reference point 6 324. Each of the reference points are in communication with the RF module, and monitors and detects the RF module entering into the multiple aisles. The reference point 1 314 detects the shopping cart 1 326 entering aisle 1 302. The central computing unit may receive the location and the time of entrance to aisle 1 302 by the shopping cart 1 326, by communicating with reference point 1 314. In this example, reference point 1 314 is assigned to monitor activities in aisle 1 302. Similarly, reference point 2 316 may monitor and detect the movement of shopping cart 2 328 in aisle 2 304.

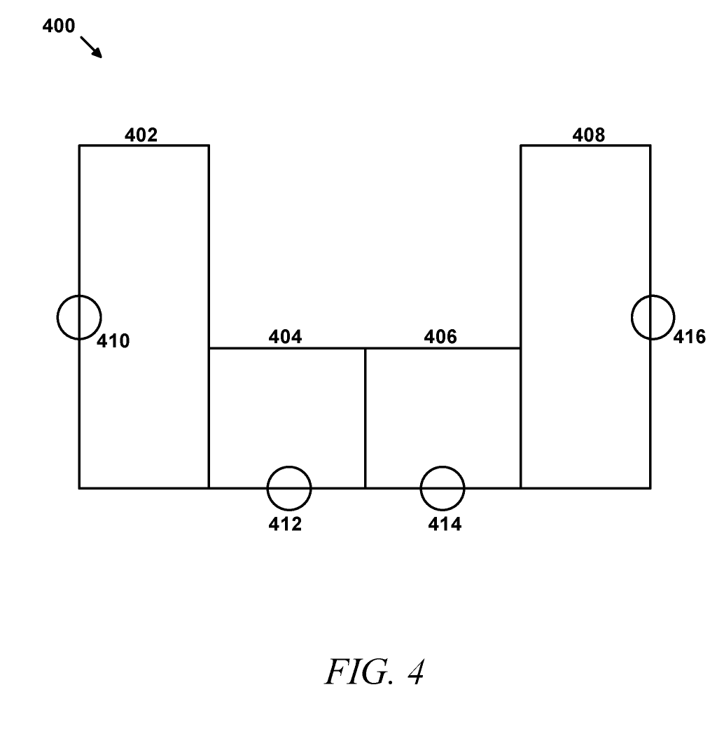

FIG. 4 illustrates an exemplary embodiment of the reference point placements in multiple stores. The store area 400 comprises the multiple stores (402, 404, 406, and 408). Each of the multiple stores are equipped with a reference point (410, 412, 414, and 416). The reference point may identify the shopping cart entering the store and exiting the store. In this exemplary embodiment, the behavior data may comprise time of entrance to the store, time of exit from the store, duration of stay in the store, and trails of the shopping cart's movement among the multiple stores 402 404 406 and 408. Similar to the reference point placements in aisles within the store, each of the multiple stores may be paired with the reference points (410, 412, 414, and 416). Each of the reference points may monitor and detect movement of the shopping cart as it enters the multiple stores. Thereby, location of the shopping cart can be monitored at the multiple stores level within the store area. This allows more granular analysis of the shopping cart's location within the store area.

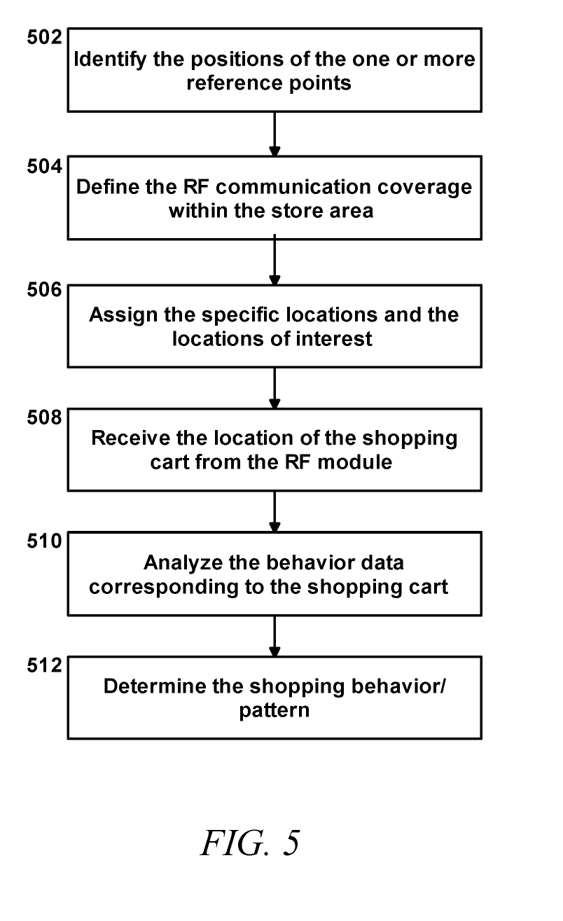

FIG. 5 illustrates a flowchart describing an exemplary method for determining a shopping behavior. The method may being with the central computing unit identifying the positions of the one or more reference points 502 placed within the store area. With the one or more reference points placed in the store area, the central computing unit may define the RF communication coverage within the store area 504. Number of the one or more reference points may cover the specific locations and/or the locations of interest. The central computing unit further assigns the specific locations and the locations of interest 506 among the one or more reference points placed in the store area. At step 508, the location of the shopping cart is received from the RF module via a corresponding reference point. Further at step 510, the behavior data corresponding to the shopping cart is analyzed by the central computing unit. The behavior data may include location, time, duration, and trail. Finally, the shopping behavior/pattern may be determined 512 by the central computing unit based on the behavior data.

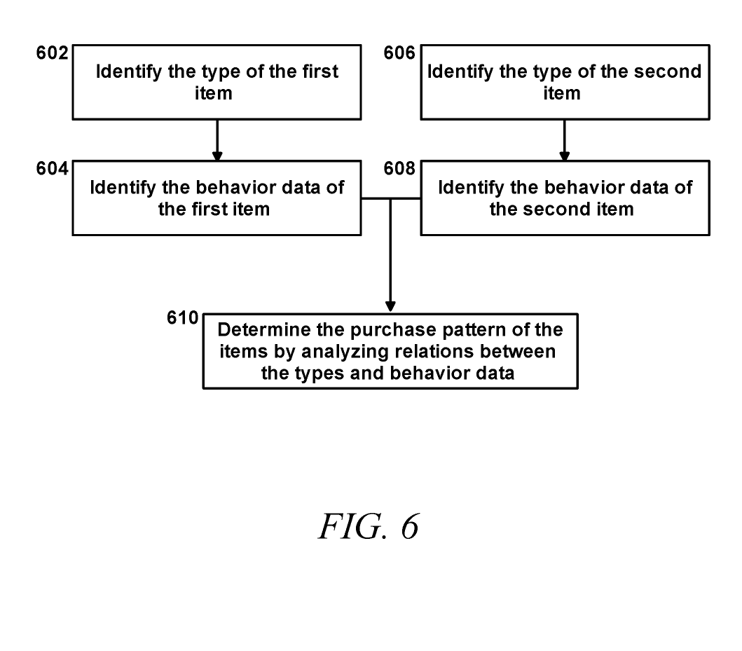

FIG. 6 illustrates a flowchart describing an exemplary method for determining the purchase pattern. The type of a first item being placed in the shopping cart 602 is identified by the central computing unit. Similarly, the type of a second item is identified at 606. The behavior data of the shopping cart in relation to the first item is identified 604 by the central computing unit. The behavior data of the shopping cart in relation to the second item is also identified at 608. Once the types and the behavior data of both the first item and the second item are identified, the central computing unit may determine the purchase pattern of the items by analyzing relations between the types and behavior data 610.

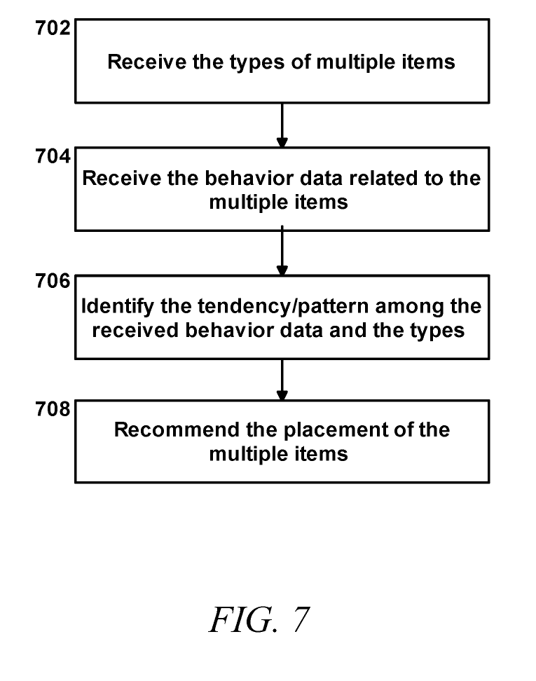

FIG. 7 illustrates a flowchart describing an exemplary method for recommending item placement. The central computing unit may receive the types of multiple items being retained by the shopping cart 702. At 704, the behavior data related to the multiple items, for example the trail of the shopping cart in the course of picking up the multiple items, is received by the central computing unit. The central computing unit further identifies the tendency/pattern among the received behavior data and the types of the multiple items 706. Finally, the central computing unit recommends the placement of the multiple items based on the identified tendency/pattern 708.

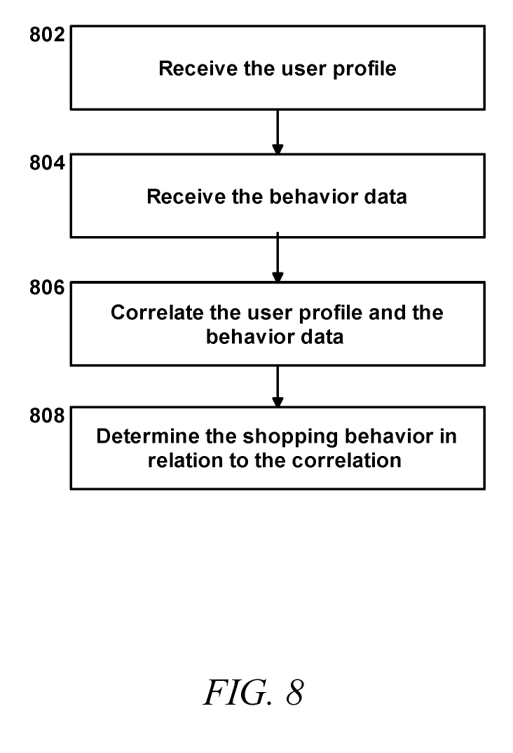

FIG. 8 illustrates a flowchart describing an exemplary method for correlating user profile with the behavior data. The central computing unit receives the user profile of the user using the shopping cart 802. Further, the central computing unit receives the behavior data of the shopping cart 804. The received user profile and the behavior data of the shopping cart is correlated 806 to determine the shopping behavior in relation to the correlation 808.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method. may be made while retaining the teachings of the present invention.

What is claimed is:

1. A system for monitoring a shopping cart location, comprising:
one or more shopping carts, each of the one or more shopping carts being equipped with an RF module;
one or more reference points in communication with the RF module, wherein the one or more reference points is positioned to provide a communication network between the RF module and the one or more reference points throughout a store area; and
one or more processors in communication with the one or more reference points and a storage unit, the storage unit storing data received from the one or more reference points, wherein the one or more processors is configured to:
identify a location of the one or more shopping carts in relation to time within the store area;
identify a duration of the one or more shopping carts being used by a user;
identify a trail of the one or more shopping carts while in use in relation to time; and
determine a shopping behavior based on a behavior data, the behavior data comprising the identified, location, duration, and trail of the one or more shopping carts.

2. The system of claim 1 wherein the one or more shopping carts comprises:
a base forming a plurality of legs radially extending away from the base, wherein a plurality of wheels are connected to the plurality of legs and positioned to enable movement of the one or more shopping carts, the base being sized to fit on an escalator step; and
an upright pole being formed vertically from the base, wherein one or more fasteners is placed along the upright pole, the one or more fasteners positioned to releasably retain a shopping bag.

3. The system of claim 1 wherein the store area comprises a multiple aisles, the one or more reference points being located at each of the multiple aisles, the one or more processors being configured to identify time of entering and exit to each of the multiple aisles by the one or more shopping carts, the behavior data further comprising the time of entering and exit to each of the multiple aisles.

4. The system of claim 1 wherein the store area comprises a multiple stores, the one or more reference points being located at each of the multiple stores, the one or more processors being configured to identify time of entering and exit to each of the multiple stores by the one or more shopping carts, the behavior data further comprising the time of entering and exit to each of the multiple stores.

5. The system of claim 1 wherein the store area comprises a multiple floor levels, a floor reference point being located at each of the multiple floor levels to define boundaries among the multiple floor levels, the floor reference point in communication with the one or more processors and the RF module, wherein the one or more processors is further configured to identify one of the multiple floor levels the one or more shopping carts is located, the behavior data further comprising the identified one of the multiple floor levels.

6. The system of claim 1 wherein the store area comprises a checkout terminal, a checkout terminal reference point being located at the checkout terminal, the checkout terminal reference point being in communication with the one or more processors and the RF module, and the one or more processors is further configured to detect the one or more shopping carts passing through the checkout terminal, the behavior data further comprising the detection.

7. The system of claim 1 further comprising a sensor located at each of the one or more shopping carts, wherein the sensor is in communication with the RF module, the sensor detecting an item being placed in the one or more shopping carts, and the behavior data further comprising the detected item.

8. The system of claim 7 wherein the one or more processors is further configured to:
identify time of the detected item being placed in the one or more shopping carts;
identify a type of the detected item, wherein a plurality of items are categorized into types, the storage unit containing an item-to-type list; and
determine a purchase pattern per the type of the plurality of items based on the identified time and the behavior data collected over time.

9. The system of claim 1 wherein the one or more processors determines the shopping behavior by ranking locations of the store area according to a traffic amount of the one or more shopping carts at each of the locations at a given time.

10. The system of claim 1 wherein the one or more processors determine the shopping behavior by ranking locations of the store area based on a frequency of visit to the locations by the one or more shopping carts over time.

11. The system of claim 1 wherein the one or more processors is further configured to:
receive a user profile from the user via a user device, the user device being in communication with the one or more processors, wherein the user profile is selected from the group consisting of age, occupation, and income level;
correlate the user profile to the behavior data; and
determine the shopping behavior based on the correlation between the user profile and the behavior data of the one or more shopping carts.

12. A method for monitoring location of one or more shopping carts, each of the one or more shopping carts being equipped with an RF module, the method being operated by one or more processors, wherein the one or more processors is in communication with a storage unit, the method comprising the steps of:
arranging one or more reference points to define a store area, the one or more reference points being in communication with the RF module, wherein the one or more reference points is positioned to provide a communication network between the RF module and the one or more reference points;
identifying a location of the one or more shopping carts in relation to time within the store area, by the one or more processors, the location being identified based on data received from the one or more reference points, the one or more processors in communication with the one or more reference points, the storage unit storing data received from the one or more reference points;
identifying a duration of the one or more shopping carts, by the one or more processors, being used by a user;
identifying a trail of the one or more shopping carts, by the one or more processors, while in use in relation to time; and
determining, by the one or more processors, a shopping behavior based on a behavior data, the behavior data comprising the identified, location, duration, and trail of the one or more shopping carts.

13. The method of claim 12 further comprising the step of identifying time of entering and exit to each of a multiple aisles by the one or more shopping carts, wherein the store area comprises the multiple aisles, the one or more reference points being located at each of the multiple aisles, the behavior data further comprising the time of entering and exit to each of the multiple aisles.

14. The method of claim 12 further comprising the step of identifying time of entering and exit to each of a multiple stores by the one or more shopping carts, wherein the store area comprises the multiple stores, the one or more reference points being located at each of the multiple stores, the behavior data further comprising the time of entering and exit to each of the multiple stores.

15. The method of claim 12 further comprising the step of identifying one of a multiple floor levels the one or more shopping carts is located, wherein the store area comprises the multiple floor levels, a floor reference point being located at each of the multiple floor levels to define boundaries among the multiple floor levels, the floor reference point in communication with the one or more processors and the RF module, the behavior data further comprising the identified one of the multiple floor levels.

16. The method of claim 12 further comprising the step of detecting the one or more shopping carts passing through a checkout terminal, via a checkout terminal reference point located at the checkout terminal, wherein the store area comprises the checkout terminal, the checkout terminal reference point being in communication with the one or more processors and the RF module, the behavior data further comprising the detection.

17. The method of claim 12 further comprising the steps of:
detecting an item being placed in the one or more shopping carts with a sensor, the sensor being located at each of the one or more shopping carts, wherein the sensor is in communication with the one or more processors;
identifying, by the one or more processors, time of the detected item being placed in the one or more shopping carts;
identifying, by the one or more processors, a type of the detected item, wherein a plurality of items are categorized into types, the storage unit containing an item-to-type list; and
determining, by the one or more processors, a purchase pattern per the type of the plurality of items based on the identified time and the behavior data collected over time.

18. The method of claim 12 wherein the step of determining the shopping behavior comprises ranking locations of the store area according to a traffic amount of the one or more shopping carts at each of the locations at a given time.

19. The method of claim 12 wherein the step of determining the shopping behavior comprises ranking locations of the store area based on a frequency of visit to the locations by the one or more shopping carts over time.

20. The method of claim 12 further comprising the steps of:
receiving a user profile from the user with a user device, the user device being in communication with the one or more processors, wherein the user profile is selected from the group consisting of age, occupation, and income level;
correlating, by the one or more processors, the user profile to the behavior data; and
determining, by the one or more processors, the shopping behavior based on the correlation between the user profile and the behavior data of the one or more shopping carts.
